(19) United States
(12) Patent Application Publication
(10) Pub. No.: US 2012/0309603 A1
(43) Pub. Date: Dec. 6, 2012

(54) METHOD FOR PRODUCING AN ADHESIVE CLOSURE PART, METHOD FOR THE PRODUCTION OF A SHAPING ROLLER AND SHAPING ROLLER

(76) Inventor: Guntmar Seifert, Plauen (DE)

(21) Appl. No.: 13/577,971

(22) PCT Filed: Feb. 8, 2011
(86) PCT No.: PCT/EP2011/000577

§ 371 Date: Aug. 9, 2012

(30) Foreign Application Priority Data
Feb. 9, 2010 (DE) 10 2010 007 494.2

(51) Int. Cl. B29C 43/24; F16C 13/00

(52) U.S. Cl. 492/57; 264/167

(57) ABSTRACT

The invention relates to a method for producing an adhesive closure part (1) comprising a support (2), a single-pieced arrangement made of projecting stems with hooking elements (4), which are mounted in the region of the stems (3) opposite the support. According to the invention, a heated thermoplastic material is guided to a gap (5) which is formed between a shaping roller provided with shaping cavities (7), and a counter surface, in particular a pressure roller (8), the heated thermoplastic material is introduced into the shaping cavities (7), the heated thermoplastic material solidifying in said shaping cavities (7), the stems (3) with hooking elements (4) are removed from the shaping cavities (7), the support (2) with the stems (3) and the hooking elements (4) is extracted continuously and the shaping roller (6) is made of, at least in the region of the shaping cavities (7), a porous material which ensures air permeability, the porous material is expanded material, sinter material, soldered and/or injected material.

The present invention relates to a method for producing an adhesive closure part according to the preamble of claim 1. Further, the present invention relates to a method for producing a shaping roller and a shaping roller.

### GENERAL FIELD OF THE INVENTION

The invention relates to the field of mechanic closures, such as Velcro or latch and hook-closures, using adhesive closure parts, for example mushroom-shaped or harpoon-shaped adhesive closures, by which a piece of clothing can be closed in a detachable fashion, diapers can be closed in a detachable fashion, as well as other objects can be connected to each other in a detachable fashion, etc.

Today, such adhesive closure parts are used in many applications.

### MOST CLOSELY RELATED PRIOR ART

A generic method for producing an adhesive closure part is known from DE 198 28 856 C1. In the method a shaping roller is used, which shows shaping cavities with undercuts. For this purpose, the shaping roller comprises a sieve with continuous cavities, which show at the side of the sieve facing away from the pressure tool a second forming element, cooperating with said cavities, for example in the form of a second sieve. The shaping roller formed this way shows shaping cavities with a gradual shape. The shaping of the stems formed with heads is therefore limited. Accordingly, in the method of prior art it is necessary to subject the ends of the stems to a post-processing step using a calendaring roller. Furthermore it is difficult to pull the first and second sieve onto the shaping roller in a precise alignment in reference to the sieve openings. Further, the sieves are made from nickel, which shows only a limited durability under thermal stress.

A method for the production of a tool via laser is known from DE 694 03 475 T2. Shaping cavities with undercuts cannot be produced using this method.

An adhesive closure part and a method for its production are discernible from DE 10 2007 057 905 A1 using a shaping roller with shaping cavities, with their walls being embodied arc-shaped. These shaping cavities also provided with undercuts are difficult to produce.

An off-set printing method for the production of an area zipper is known from DE 692 18 952 T2, in which a porous roller is used with an inner storage container so that molten material located inside the storage container can be supplied to the operating area due to the porosity.

A method and a device for producing an area adhesive closure are known from DE 694 22 273 T2, in which first a tape is generated provided with hooks, and simultaneously or in a second, subsequent processing step additionally loop elements are applied by another shaping roller. In the area of this additional shaping roller a suction sector is provided on the inside thereof.

Finally, a method is known from DE 698 22 852 T2 for the production of the surface of a shaping roller with shaping cavities comprising undercuts. Here, successively very thin layers are galvanically applied on the surface of a work piece in predetermined patterns. Porous nickel may be used as the material which allows the option that any air trapped during the filling of the shaping cavities can evaporate from the shaping cavity. The production of shaping cavities takes weeks and thus is very time-consuming. The porosity achieved in this method is therefore limited by processing technology to an extremely fine porosity.

### OBJECTIVE OF THE PRESENT INVENTION

The objective of the present invention comprises to provide a novel, generic method allowing the formation of multi-structural hooking elements, i.e., hooking elements in an arbitrary shape in a simple and effective fashion.

Further, a novel method shall be provided to produce a shaping roller as well as a novel shaping roller.

### OBJECT OF THE PRESENT INVENTION

The present objective is attained in a method for producing an adhesive closure part with, a carrier, a one-piece arrangement comprising projecting stems with heads at the ends of the stems opposite the carrier, in which a heated, thermoplastic material is supplied to a gap, which is formed by a shaping roller equipped with shaping cavities as well as a counter surface, particularly a pressure roller, with the heated thermoplastic material being inserted into the shaping cavities, the heated thermoplastic material being solidified in the shaping cavities, the stems with the heads being removed from the shaping cavities, the carrier with the stems and the heads being continuously pulled off, and the shaping roller comprising a porous material in the area of the shaping cavities at least sectional, which ensures air permeability, with the porous material representing material foam, sintered material, welded and/or injection-molded material. For this reason any air trapped can evacuate from the shaping cavities during the filling process.

Beneficially the shaping cavities represent those with undercuts. The porous material extends along the longitudinal extension of the shaping cavities.

Beneficially the jacket surface of the shaping roller, thus the exterior section of the porous material, is sealed towards the outside, for example by applying an additional layer or by mechanic processing. The sealing causes that, during the application of a vacuum or pressure upon the porous material, the effect of pressure reduction or pressure increase, respectively, is of a particularly strong effect in the shaping cavities. Additionally or alternatively this was a different surface structure can be achieved in the area of the carrier.

According to one aspect of the invention the pores also serve to accept any molten material during the filling of the shaping cavities, thus these areas, after the removal, are present as projections protruding from the stem and additionally acting as hooking means, which increase the intensity of linking with a loop material or the like.

The demolding of the hooking elements, particularly when they extend with their projections additionally into the porosity of the form material, is facilitated such that in the area of the shaping cavities a coating is provided increasing the gliding abilities, preferably a nano-coating.

The type of porosity of the pressure roller allows not only that air can evacuate via the porosity during the filling process but also that actively a vacuum and/or a pressure can be adjusted in a targeted fashion. This supports the demolding of more complicated parts and allows a rapid and thus more efficient operation.

This impingement of the shaping cavities with pressure or vacuum can be provided such that depending on the rotary position either a vacuum or a pressure is applied at the shaping cavities.

The orientation of the shaping cavities of the porous layer is essentially perpendicular. The perpendicular orientation is formed by a processing performed essentially perpendicular in reference of the jacket surface, such as a drilling, laser processing, or erosion. At the section of the shaping cavity opposite the jacket surface an expanding wall section follows the wall section extending perpendicular in reference to the surface. This may beneficially be generated by a subsequent etching, preferably a spray etching.

Particularly good results are yielded when the permeability of the porosity ranges from 0.010-0.09 l/min-cm²-bar, preferably 0.015-0.08 l/min-cm²-bar, particularly preferred 0.02-0.07 l/min-cm²-bar, with a pressure being applied from 3 bar to 7 bar. This range of porosity supports the possibility of an active impingement of the shaping cavities using a vacuum or pressure.

The present invention further relates to a method for producing a shaping roller for the use in a method according to at least one of the previous claims. According to the method a one-piece porous layer is produced, with the porous layer being connected to a basic carrier of a shaping roller. Subsequently holes are inserted into the porous layer.

The expanding area is produced by way of etching, preferably spray etching.

The jacket surface of the mold comprising the porous layer is sealed in the area of the outside of the shaping roller.

The present invention further also relates to a shaping roller used for the method described in claims 1-11.

### EXEMPLARY EMBODIMENTS OF THE INVENTION

Beneficial embodiments of the present invention are explained in greater detail using the figures of the drawing. In the figures:

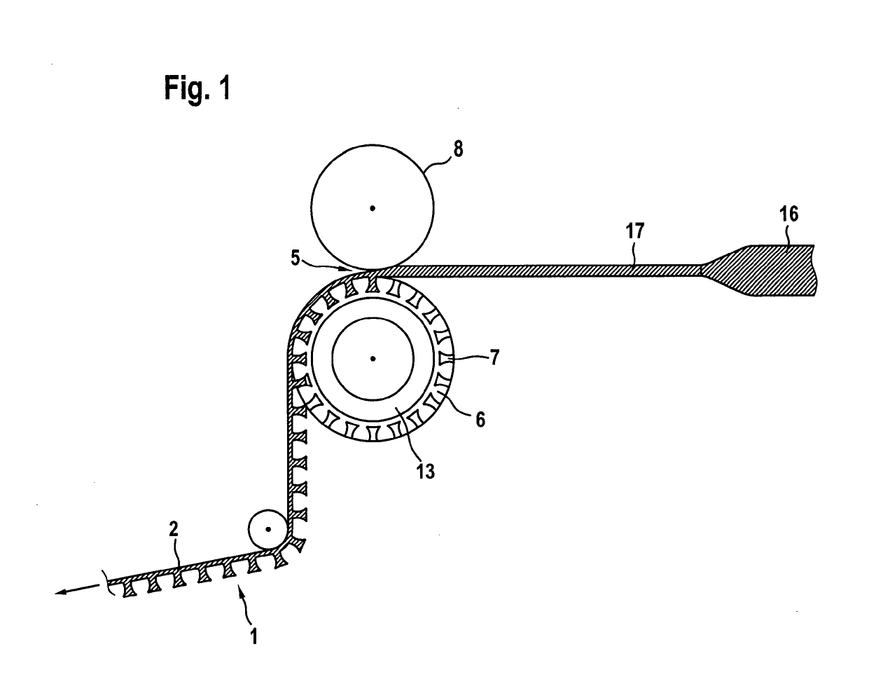

FIG. 1: shows a largely simplified schematic illustration of the basic principle of the production of an adhesive closure part according to the present invention;

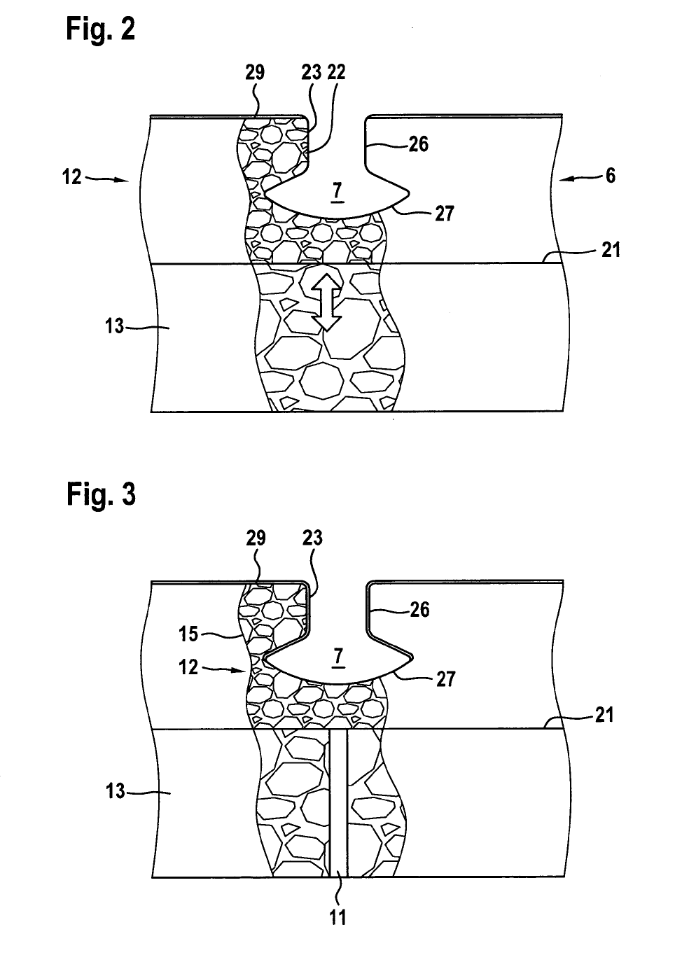

FIG. 2: shows a largely simplified schematic detailed illustration in a partial cross-section through the shaping roller in the area of a shaping cavity according to a first embodiment;

FIG. 3: shows a largely simplified schematic detailed illustration in a partial cross-section through the shaping roller in the area of a shaping cavity according to a second embodiment of the present invention;

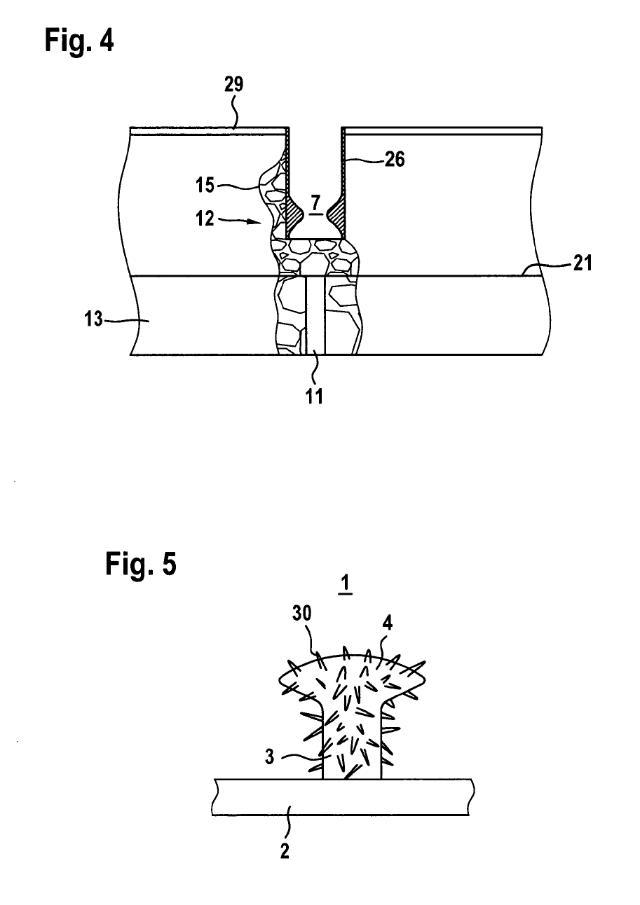

FIG. 4: shows a largely simplified schematic detailed illustration in a partial cross-section through the shaping roller in the area of a shaping cavity according to a third embodiment of the present invention;

FIG. 5: shows a largely simplified schematic illustration of a mushroom-shaped stem, produced by the use of a mold according to FIG. 2;

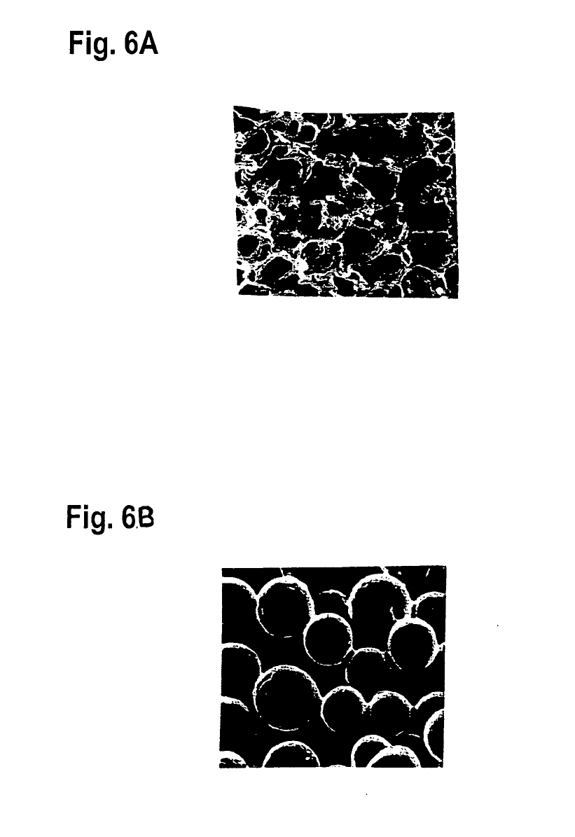

FIG. 6: shows an exemplary microscopic image of a foamed metallic material (FIG. 6A) and a sinter material (FIG. 6B), respectively;

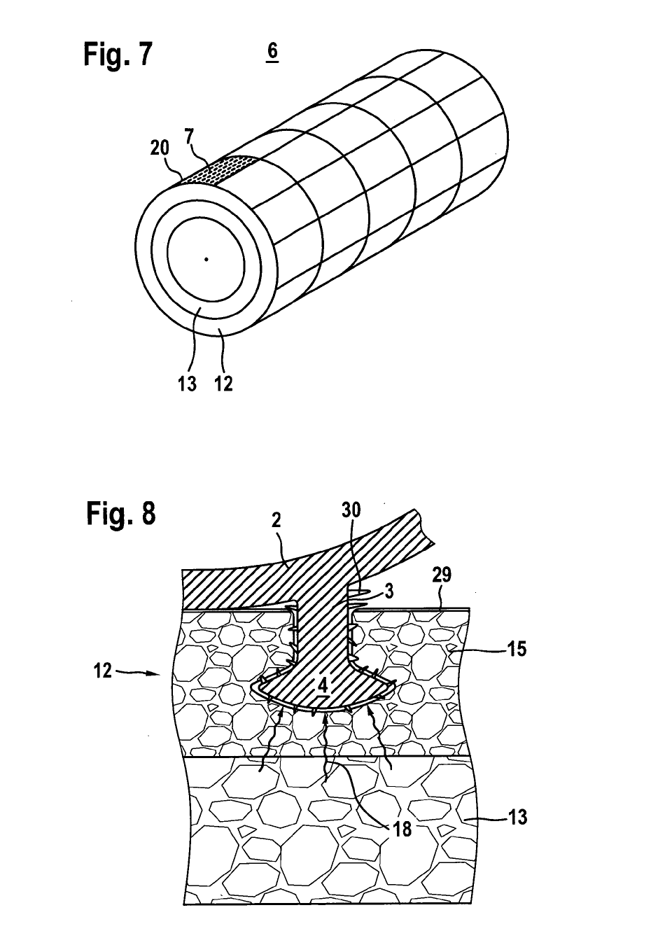

FIG. 7: shows a largely simplified schematic perspective view of a partial section of the shaping roller;

FIG. 8: shows a largely simplified schematic illustration of the shaping roller with the operating point A (filling the shaping cavities) as well as B (demolding the shaped blanks from the shaping cavity), respectively, and

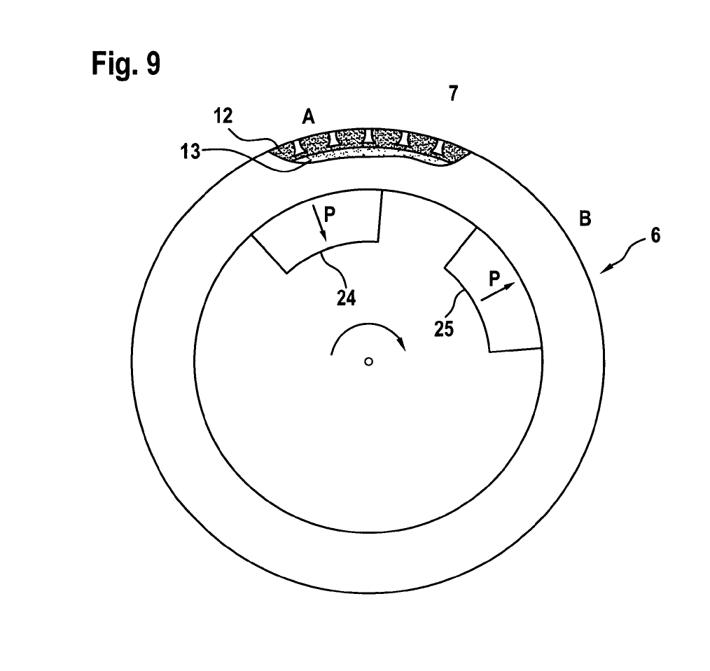

FIG. 9: shows a largely simplified schematic partial cross-section of the shaping roller with segmental applied vacuum and pressure upon the shaping cavities.

The reference character 1 in FIG. 1 marks the adhesion closure part in its entirety. It comprises a carrier 2 as well as stems 3 projecting from the base area of the carrier, with an expanded hooking element 4 following at the end opposite the carrier 2.

In order to produce the adhesion closure part 1 a thermoplastic material, for example polyethylene, polypropylene, or the like, is supplied from an extruder 16 in form of a molten mass 17 to a roller gap 5. The roller gap 5 is formed by a shaping roller 6 as well as a pressure roller 8.

In the area of its circumferential exterior surface the shaping roller 6 comprises a plurality of minute shaping cavities 7. The shaping cavities are displayed in FIG. 1 very enlarged for reasons of better visibility. Actually, commonly 10-900 shaping cavities may be located within one square centimeter, beneficially 150 to 400. The area of the shaping roller 6 comprising the shaping cavities is applied onto the basic carrier 13 of the shaping roller 7.

In the roller gap 5 the molten thermoplastic material is pressed into the individual shaping cavities 7. The shaping roller 6 and the pressure roller 8 are both kept at a suitable temperature, i.e., tempered, in order to ensure that the molten thermoplastic material is solidified in the area of the roller gap 5 as well as the shaping cavity.

After the solidification at an operating point located at the perimeter of the shaping roller the adhesion closure part 1 is pulled off and the stems 3 with the hooking elements 4 located thereat are removed from the shaping cavities 7. This way, the adhesion closure part immediately comprises stems 3 with hooking elements 4 located thereat, which can be used per se without any post-processing, e.g., without any calendaring using a calendaring roller.

Alternatively there is the option to modify the shape of the hooking elements 4 within the scope of a subsequent processing step (not shown in FIG. 1) using a heating device (e.g., plasma), an ultrasound sonotrode, a calendar roller, or a combination of the above-mentioned methods, for example flattening. As discernible from FIG. 1 the method discussed represents a continuous production process.

FIG. 2 shows the shaping cavities 7 (in FIG. 2 only a single one is shown for reasons of clarity). The shaping roller 6 comprises a layer 12 made from a porous material with open porosity. In case of the embodiment according to FIG. 2 this represents a material sprayed on, particularly metal. The pores 22 perforate the wall section 26 extending perpendicularly and allow that due to the air permeability molten material can penetrate into these channels 22 and solidify here. Furthermore no air pocket develops inside the shaping cavities 7 during the filling process. The layer 12 made from a porous material is located on a base carrier 13 of the shaping roller 6. The base carrier 13 may either comprise a porous material or (not shown in FIG. 2) show channels provided to evacuate air from the area 12 or supply it to the above-mentioned area. The exterior jacket surface of the pressure roller 6 may be sealed via a layer 29 towards the outside, as shown in the figure. The layer 29 may represent an additionally applied layer or a mechanically or thermally compressed layer of the material of the layer 12 of the porous material.

If no vacuum is applied the layer 29 may be waived, here.

Additionally, it is not necessary for the melt to penetrate the channels 22. If the channels 22 are of smaller dimensions, air can evacuate through them without any molten material penetrating into the respective channel.

The layer 12 is connected to the base carrier 13 of the shaping roller 6 via a connection layer, e.g., an adhesive layer 21. The adhesive layer 21 is provided to ensure air permeability only at partial areas. For example the adhesive area may be formed as a segmented area, e.g., such that the adhesive surface is effective or present only in the intermediate sections between two shaping cavities 7.

The shaping cavity 7 comprises a perpendicularly extending wall section 26 as well as an expanded wall section 27 following the end of said wall section.

This shaping results such that first the perpendicularly extending wall section 26 is generated continuously, for example by using a drill, laser, or erosion. Subsequently by the so-called spray etching an expanding wall section 27 is formed at the bottom end of the perpendicularly extending wall section.

According to the present invention here a shaping cavity 7 is formed with undercuts. The adhesion closure part produced from the shaping cavity according to FIG. 2 shows a stem 3 with an expanding head, i.e., hooking element 4, with individual appendage like projections 30 are provided at the stem 3 as well as the expanded head (cf. FIG. 5). The above-mentioned projections 3 [sic: 30] may be provided for certain requirements.

In order to facilitate stems embodied in this manner a coating increasing the gliding ability of the set material may be provided in the area of the shaping cavity 7, for example a nano-particle layer 23. The nano-particle layer 23 is located in the shaping cavity 7 shown in FIG. 2, both in the area of the perpendicularly extending wall section 26 as well as at least partially inside the pores 22 branching off, here. The same applies for the pores branching off the expanding wall section 27.

The porous material of the layer 12 shown in FIG. 2 represents a foamed hard material, particularly a foamed metal.

In the embodiment shown in FIG. 3 a so-called sinter material is provided in the area of the layer 12, which also ensures open porosity. Here, too, the shaping cavity 7 is connected, via the porosity of the layer 12 as well as, e.g., in this case, via a ventilation channel 11 of the base carrier 13, to a vacuum pump (not shown) or a pressurizing pump (not shown). The ventilation channel 11 may also serve only for air trapped in the shaping cavity 7 to evacuate (without any pump for applying a vacuum or pressure).

The other features of the shaping roller 6 according to FIG. 3 are equivalent to the embodiment according to FIG. 2.

In an alternative embodiment of the shaping roller according to the invention, discernible in FIG. 4 an undercut is achieved at the head located at the stem such that a galvanic application 28 is generated inside the shaping cavity 7 with a diameter varying along the elevation of the shaping cavity 7. This galvanic application 28 generates an undercut inside the shaping cavity 7 and accordingly a head section projecting outwardly in the demolded product.

There are various options with regard to the production of the porous layer 12. It is important that a defined pore size can be generated by the respective method, which allows a defined air passage for suctioning the shaping cavities 7 and/or applying pressure upon the shaping cavities. This in turn facilitates the production of adhesion closure parts 1 with various hooking elements 4. The pore size should be greater than 10 μm, preferably greater than 15 μm, preferably greater than 20 μm.

Particularly the following methods are available to generate the layer 12 comprising a porous material:
a) Sprayed material, particularly metal (AL, CU, steel including its alloys or plastic, such as calcified carbon or graphite) in the form of sprayed or bonded particles, plasma-powder build-up welding, plasma spraying, heat spraying, arc spraying, HVOF-spraying. Primarily powdered spray materials with a grain size ranging from 1-150 μm are applied. However, it is also possible to use a rod-shaped or wire-shaped material;
b) Plasma-powder application welding;
c) Sintering; here, a bulk of the particles with a certain grain size or grain size distribution of the above-mentioned material is bonded under pressure and high temperature to form a solid body, which shows porosity. The porosity to be achieved can be influenced in a targeted fashion by selecting the particle sizes appropriately;
d) Foamed material, particularly open-pored metallic foam; the production of metallic foam occurs via a metallic powder and a metal hydride, e.g., titanium dehydride. Both powders are mixed with each other and then compacted by compression to form a precursor material. The precursor material is then heated to a temperature above the melting point of the metal. Here, the titanium dehydride releases gaseous hydrogen and foams the mixture. Alternatively, gas may also be injected into a metallic melt, which was previously made frothy by the addition of solid components. Furthermore, there is the so-called slurry reaction foam-sintering method (SRSS-method), by which particularly iron, steel, and nickel foams can be produced.

A particularly rapid entering of the melt into the shaping cavities due to the vacuum present here directly during the filling process as well as further an effective expression of the solidified blank in the area of the operating point of the demolding of the blank from the shaping cavity by the presence of a pressure in the shaping cavity decisively contributes to the increase of the throughput speed of the production method. The application of a vacuum is not mandatory, though.

All of the above-mentioned methods have in common that sufficient porosity can be achieved thereby. Contrary thereto, using a galvanic method, the generation of such porosity is not possible. A microscopic imaging of metallic foam with open porosity is discernible from FIG. 6A. FIG. 6B shows a microscopic image of a sintered body and its porosity caused by the arrangement of the individual particles.

The layer 12 made from a porous material is beneficially produced as a one-piece planar layer, and subsequently applied onto a base carrier 13 and connected to the latter, for example adhered partially to the base body 12 via an adhesive layer 21. The layer thickness 12 ranges from 0.1-15 mm, beneficially ranging from 400 to 600 μm. The adhesive layer 21 is provided with a structuring, for example a plurality of penetrating openings or penetrating surfaces, in order to allow air to penetrate.

In case of a sprayed-on or welded-on porous material, this may occur directly on the shaping roller 6 or its base carrier 13.

Preferably, individual segments 20, as shown in FIG. 7, are connected to each other along the surface of the shaping roller 6 until the entire surface of the shaping roller 6 is covered with segments 20. This represents jacket segments with a minimum number of three segments 20 along the perimeter of the shaping roller 6. For reasons of display, FIG. 7 only shows the shaping cavities 7 in one segment 20, although actually they are present in all segments 20.

Due to the porosity of the layer 12, during the demolding process, which is shown largely simplified in a schematic fashion in FIG. 8, the shaping cavity 7 can be supported by applying a pressure (air pressure flow 18) into its interior. The position shown in FIG. 8 represents the demolding position B, as illustrated in FIG. 9 with reference to the position in reference to the shaping roller 6.

Additionally, the filling of the shaping cavities 7 with a thermoplastic resin (see position A in FIG. 8) may also be supported by applying a vacuum inside the shaping cavity 7.

For example, the shaping roller 6 according to FIG. 9 may beneficially show a segment 24, which is provided to generate a vacuum in the shaping cavity 7 as well as a segment 25, which is provided for generating a pressure in the shaping cavity 7. The segments 24 and 25 are locally fixed, i.e., the shaping roller 6 rotates during the production of the adhesion closure part 1 over the two segments 24, 25. For better visibility the adhesion closure part 1 and the pressure roller 8 are not shown in FIG. 9. When here the shaping roller rotates continuously during the production process of the adhesion closure part 1 a vacuum is applied upon the shaping cavity 7 of the shaping roller 6 in the area of the segment 24 and the shaping roller 6 is impinged with a vacuum in the operating area A. This allows that the thermoplastic melt can quickly reach the shaping cavities 7, and cure there.

However, in the area of the segments 25, at the operating point B (demolding) a pressure is applied, which facilitates the demolding of the stem 3 with the hooking elements 4 from the shaping cavity 7, as shown in FIG. 8 in a simplified fashion. The porosity of the layer 12 therefore allows performing a particularly efficient method. The pores of the material of the layer 12 range from 10 μm to 100 μm, preferably from 20 μm to 80 μm.

Also covered by the patent protection is a shaping roller, which has been produced by the above-mentioned process, and it is explicitly pointed out that individual features of the exemplary embodiments shown may be interchangeable, i.e., are covered by the disclosure of the application.

The method according to the invention allows producing in an effective manner the adhesion closure part with stems and engaging elements located thereat. The invention therefore provides an essential contribution for the respective field of technology.

### LIST OF REFERENCE CHARACTERS

1 adhesion closure part

2 carrier

3 stems

4 hooking element

5 roller gap

6 shaping roller

7 shaping cavities

8 pressure roller

9 position

10 position

11 ventilation channel

12 layer

13 base carrier

14 air flow

15 grained material

16 extruder

17 molten material

18 pressurized air flow

19 particles

20 segment

21 adhesive layer

22 pore

23 nano-particle layer

24 segment vacuum

25 segment pressure

26 perpendicularly extending wall section

27 expanding wall section

28 galvanic application

29 layer

30 projection

1. A method for producing an adhesion closure part with a carrier, a one-piece arrangement with projecting stems comprising hooking elements in a the area of the stems opposite the carrier, in which
a heated, thermoplastic material is supplied to a gap, which is formed by a shaping roller equipped with shaping cavities as well as a counter surface, particularly a pressure roller,
the heated, thermoplastic material is inserted into the shaping cavities,
the heated, thermoplastic material sets in the shaping cavities,
the stems with the hooking elements are removed from the shaping cavities,
the carrier with the stems and the hooking elements is continuously pulled off, and
the shaping roller comprises a porous material in the area of the shaping cavities, at least sectional, which ensures air permeability,
wherein
the porous material represents a foamed material, sinter material, build-up welded and/or sprayed-on material.

2. A method according to claim 1,
wherein
the jacket surface of the shaping roller is provided with a layer preventing or at least reducing the air penetration in reference to the porous material.

3. A method according to claim 1,
wherein
in the area of the shaping cavity, caused by the size of the pores adjacent to the wall of the shaping cavity, molten material penetrates into the pores and it is present as projections protruding from a stem at the adhesion closure part after the removal of the shaping cavity.

4. A method according to claim 1,
wherein
the surface is coated in the area of the shaping cavity, preferably including at least a portion of the pores, with a coating increasing the gliding ability, preferably a nano-particle layer.

5. A method according to claim 1,
wherein
before and/or during the filling of the shaping cavity the air located in the latter is suctioned off via the porosity of the material of the shaping roller.

6. A method according to claim 1,
wherein
in order to support the removal of the stems with the hooking elements via the porosity of the material of the shaping roller a pressure is generated inside the shaping cavity.

7. A method according to claim 1,
wherein
depending on the rotary position of the shaping roller, either a vacuum or a pressure is generated inside the shaping cavities.

8. A method according to claim 1,
wherein
the orientation of the shaping cavity is essentially perpendicular in reference to the jacket surface of the shaping roller.

9. A method according to claim 1,
wherein
the shaping cavity comprises a wall section preferably extending essentially perpendicular in reference to the surface as well as an expanding wall section following thereto.

10. A method according to claim 1,
wherein
a partial section of the shaping cavity, preferably the expanding wall section of the shaping cavity, is etched, preferably spray etched.

11. A method according to claim 1,
wherein
a partial section of the shaping cavity, preferably the wall section of the shaping cavity extending essentially perpendicularly in reference to the surface, is drilled, eroded, or inserted by a laser.

12. A method according to claim 1,
wherein
the porosity amount in l/min-cm²-bar ranges from 0.010-0.09, preferably 0.015-0.08 l/min-cm²-bar, particularly preferred from 0.02-0.07 l/min-cm²-bar, when a pressure is applied from 3 bar to 7 bar.

13. A method for the production of a shaping roller to be used in a method according to claim 1,
wherein
a one-piece porous layer is produced, the porous layer is connected to a base carrier of the shaping roller, and subsequently holes are inserted into the porous layer.

14. A method according to claim 13,
wherein
subsequently by way of etching, preferably spray etching, the expanding area is formed.

15. A method according to claim 13,
wherein
the porous layer is sealed towards the outside in the area of the jacket surface of the shaping roller.

16. A shaping roller for the use in a method according to at least one method according to claim 1,
wherein
the roller is produced according to a method wherein a one-piece porous layer is produced, the porous layer is connected to a base carrier of the shaping roller, and subsequently holes are inserted into the porous layer.
